(19) United States
(12) Patent Application Publication
(10) Pub. No.: US 2020/0062210 A1
(43) Pub. Date: Feb. 27, 2020

(54) PASSENGER PROTECTING DEVICE

(71) Applicant: TOYOTA JIDOSHA KABUSHIKI KAISHA, Toyota-shi (JP)

(72) Inventor: Osamu FUKAWATASE, Miyoshi-shi (JP)

(73) Assignee: TOYOTA JIDOSHA KABUSHIKI KAISHA, Toyota-shi (JP)

(21) Appl. No.: 16/455,970

(22) Filed: Jun. 28, 2019

(30) Foreign Application Priority Data
Aug. 24, 2018 (JP) 2018-157005

(51) Int. Cl. B60R 21/231

(52) U.S. Cl. CPC B60R 21/231; B60R 2021/23169; B60R 2021/23161

(57) ABSTRACT

A passenger protecting device that includes: a first inflating portion that is provided between vehicle seats disposed so as to face one another, and that inflates in a vehicle vertical direction with respect to a floor of a vehicle body due to gas being supplied to an interior of the first inflating portion; and a second inflating portion that is connected to the first inflating portion and that inflates due to gas being supplied thereto from the first inflating portion, in a state after inflation, the second inflating portion being disposed so as to face, in a seat longitudinal direction, passengers in a state in which the passengers are seated in the vehicle seats that are disposed so as to face one another, and being apart from the floor of the vehicle body.

### CROSS-REFERENCE TO RELATED APPLICATION

This application is based on and claims priority under 35 USC 119 from Japanese Patent Application No. 2018-157005 filed on Aug. 24, 2018, the disclosure of which is incorporated by reference herein.

### BACKGROUND

### Technical Field

The present disclosure relates to a passenger protecting device.

### Related Art

Japanese Patent Application Laid-Open (JP-A) No. 2017-149331 discloses a passenger protecting device that reduces the injury values of passengers who are seated in vehicle seats that are disposed so as to face one another in the longitudinal direction of a vehicle. In this passenger protecting device, at the time of a collision of the vehicle, by expanding a traversing airbag between vehicle seats that are disposed so as to face one another, the traversing airbag is interposed between the passengers who are seated in these vehicle seats. Due thereto, the knees of the passengers who are seated in these vehicle seats contacting one another can be suppressed.

From the standpoint of reducing the injury values of passengers who are seated in vehicle seats that are disposed so as to thee one another, it is important to expand the airbag (the inflating portion) quickly between the vehicle seats.

### SUMMARY

An aspect of the present disclosure is a passenger protecting device that includes: a first inflating portion that is provided between vehicle seats disposed so as to face one another, and that inflates in a vehicle vertical direction with respect to a floor of a vehicle body due to gas being supplied to an interior of the first inflating portion; and a second inflating portion that is connected to the first inflating portion and that inflates due to gas being supplied thereto from the first inflating portion, in a state after inflation, the second inflating portion being disposed so as to face, in a seat longitudinal direction, passengers in a state in which the passengers are seated in the vehicle seats that are disposed so as to face one another, and being apart from the floor of the vehicle body.

### BRIEF DESCRIPTION OF THE DRAWINGS

FIG. 1 is a perspective view showing a portion of a cabin of a vehicle that is equipped with a passenger protecting device of a first embodiment.

FIG. 2 is a perspective view showing a state after operation of the passenger protecting device of the first embodiment.

FIG. 3 is a perspective view that corresponds to FIG. 2 and shows a state after operation of a passenger protecting device of a second embodiment.

FIG. 4 is a perspective view that corresponds to FIG. 2 and shows a state after operation of a passenger protecting device of a third embodiment.

FIG. 5 is a perspective view that corresponds to FIG. 2 and shows a state after operation of a passenger protecting device of a fourth embodiment.

### DETAILED DESCRIPTION

### Passenger Protecting Device 10 of First Embodiment

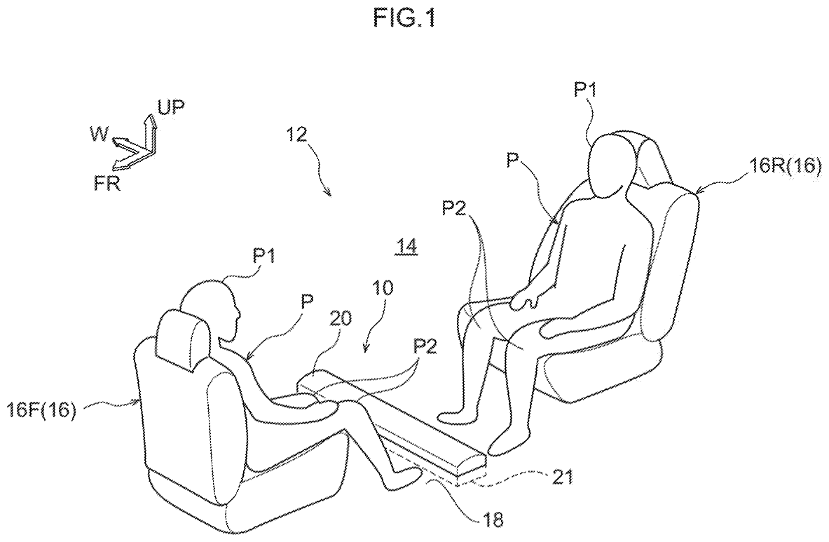

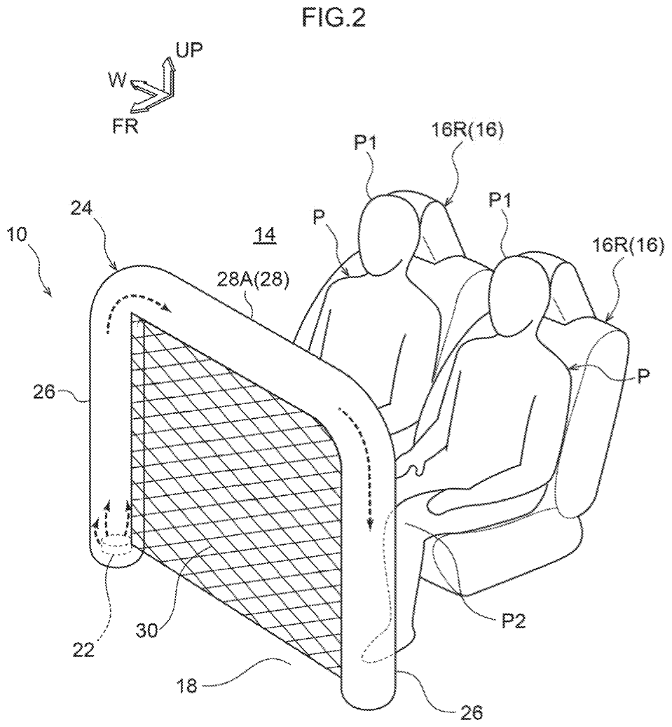

A passenger protecting device 10 relating to a first embodiment of the present disclosure is described by using FIG. 1 and FIG. 2. Note that arrow FR that is shown appropriately in the respective drawings indicates the vehicle longitudinal direction front side, arrow UP indicates the vehicle vertical direction upper side, and arrow W indicates a vehicle transverse direction one side. Further, when description is given by merely using longitudinal and vertical directions hereinafter they refer to the longitudinal of the vehicle longitudinal direction and the vertical of the vehicle vertical direction, unless otherwise specified. Note that the vehicle longitudinal direction coincides with a seat longitudinal direction seen from rear seats 16R that are described later.

As shown in FIG. 1, the passenger protecting device 10 of the present embodiment is provided in a cabin 14 of a self-driving vehicle 12 that does not have a driver's seat. Note that the passenger protecting device 10 of the present embodiment can also be applied to self-driving vehicles that have a driver's seat and in which the orientation of vehicle seats can be made to face toward the vehicle rear side.

Four vehicle seats 16, which are disposed so as to face one another in the longitudinal direction, are provided in the cabin 14 of the vehicle 12. Due thereto, the seating capacity of the vehicle 12 of the present embodiment is four. Here, the vehicle seats 16 that are disposed at the front side are called front seats 16F, and the vehicle seats 16 that are disposed at the rear side are called the rear seats 16R. Note that, in FIG. 1, illustration of the front seat 16F and the rear seat 16R that are disposed at a vehicle transverse direction one side is omitted.

The passenger protecting device 10 of the present embodiment is provided at the central portion of a floor 18 of the cabin 14 (the floor 18 of the vehicle body), between the front seats 16F and the rear seats 16R. In the state in which an airbag case 21 of the passenger protecting device 10 is mounted (fixed) to the floor 18, a top plate portion 20 of the passenger protecting, device 10 is exposed toward the cabin 14 side. The top plate portion 20 is formed in an elongated shape whose length direction is the vehicle transverse direction The dimension of this top plate portion 20 in the vehicle transverse direction is set to a dimension that corresponds to the front seats 16F and the rear seats 16R that are disposed adjacent in the vehicle transverse direction. Further, due to the top plate portion 20 breaking, an inflating portion 24 and a first partitioning wall shaped member 30 (see FIG. 2) that are described later expand from the floor 18 toward the, upper side. Note that markings that express that placing baggage on the top plate portion 20 is to be avoided, or the like, are provided on the top plate portion 20.

As shown in FIG. 2, the passenger protecting device 10 has an inflator 22 that generates gas by being operated, the inflating portion 24 that is formed in the shape of a bag and that inflates due to the gas generated by the inflator 22 being supplied to the interior, and the first partitioning wall shaped member 30 that connects the inflating portion 24 and the floor 18. Note that the inflator 22, the inflating portion 24 and the first partitioning wall shaped member 30 are disposed within the airbag case 21 that is fastened and fixed directly or via brackets to frame members that are disposed at the reverse surface side of the floor 18. The open end side of the airbag case 21 is closed by the top plate portion 20.

The inflating portion 24 has a pair of first inflating portions 26 that inflate from the floor of the vehicle body in the vehicle vertical direction due to gas being supplied to the interiors thereof, and a second inflating portion 28 that is connected to the pair of first inflating portions 26 and that connects the upper end portions of the pair of first inflating portions 26 in the vehicle transverse direction.

The pair of first inflating portions 26 are respectively disposed at a vehicle transverse direction one side end portion and another side end portion of the cabin 14, and, in the states after inflation, are formed in the shapes of cylindrical tubes whose length directions are the vertical direction. Further, in the present embodiment, the inflator 22 is connected to the lower end portion of the first inflating portion 26 that is at a vehicle transverse direction one side among the pair of the first inflating portions 26.

The second inflating portion 28 is disposed so as to, in the state after inflation, be apart from the floor 18, and so as to span between the upper end portions of the pair of first inflating portions 26. In the state after inflation, the second inflating portion 28 is formed in the shape of a cylindrical tube whose length direction is the vehicle transverse direction, Further, the second inflating portion 28 is disposed so as to face, in the seat longitudinal direction, passengers P who are seated in the front seats 16F and the rear seats 16R, and is apart from the floor 18. In further detail, in the present embodiment, the second inflating portion 28 is a head portion facing portion 28A that is disposed so as to face, in the seat longitudinal direction, head portions P1 of the passengers P who are seated in the front seats 16F and the rear seats 16R. The height, from the floor 18, of this head portion facing portion 28A is set in consideration of the locus of movement of the head portion P1 at the time of a collision. For example, in a case in which the passenger P is wearing a three-point seatbelt, it is thought that, at the time of a collision, the head portion P1 will approach the head portion facing portion 28A while moving in the vehicle transverse direction. The height of the head portion facing portion 28A from the floor 18 is set in consideration of this locus of movement of the head portion P1. Note that, in FIG. 2, illustration of the front seats 16F and the passengers P who are seated in the front seats 16F is omitted.

Because the inflating portion 24 has the above-described pair of first inflating portions 26 and second inflating, portion 28, the inflating portion 24 inflates in an upside-down U-shape as seen from the seat from side or rear side.

Further, the passenger protecting device 10 of the present embodiment has the first partitioning wall shaped member 30 that serves as a partitioning wall shaped member, and that connects the second inflating portion 28 and the floor 18 (specifically, the airbag case 21 that is fastened and fixed to the floor 18) at the lower side of the second inflating portion 28 after inflation, and that partitions the front seats 16F and the rear seats 16R in the longitudinal direction. Further, the first partitioning wall shaped member 30 connects the pair of first inflating portions 26 in the vehicle transverse direction. Note that, for example, a member, which is mesh-like and is joined to the inflating portion 24, or a member, which is cloth-like and is formed integrally with the inflating portion 24 and is of the same material as the inflating portion 24, can be used as the first partitioning wall shaped member 30,

### Operation and Effects of Present Embodiment

Operation and effects of the present embodiment are described next.

As shown in FIG. 1 and FIG. 2, during traveling of the vehicle 12 that is equipped with the passenger protecting device 10 of the present embodiment, the inflator 22 is operated in a case in which the vehicle 12 is involved in a collision or in a case in which there is a high possibility that the vehicle 12 will be involved in a collision.

The gas, which is generated due to the inflator 22 being operated, is supplied into the inflating portion 24, and the inflating portion 24 starts to inflate. The top plate portion 20 is pushed by the inflating portion 24 that has started to inflate, and the top plate portion 20 is broken. Due thereto, the inflating portion 24 expands into the cabin 14.

Here, the gas that is generated by the inflator 22 is supplied to the first inflating portion 26 that is at a vehicle transverse direction one side among the pair of first inflating portions 26 that structure portions of the inflating portion 24. Therefore, the first inflating portion 26 that is at the vehicle transverse direction one side inflates in the vehicle vertical direction from the floor. Further, the second inflating portion 28 inflates due to gas being supplied (gas flowing) to the second inflating portion 28 from the first inflating portion 26 that is at the vehicle transverse direction one side. Moreover, the first inflating portion 26 that is at the vehicle transverse direction another side inflates in the vehicle vertical direction from the floor due to gas being supplied (gas flowing) from the second inflating portion 28 to the first inflating portion 26 that is at the vehicle transverse direction another side. Due thereto, expansion of the inflating portion 24 into the cabin 14 is completed.

Then, in the state in which expansion of the inflating portion 24 into the cabin 14 is completed, at the time when the passengers P who are seated in the front seats 16F and the rear seats 16R move toward the seat front sides, i.e., at the time when the passengers P who are seated in the front seats 16F move toward the vehicle rear side or the time when the passengers P who are seated in the rear seats 16R move toward the vehicle front side, the head portions PI of the passengers P can be restrained by the second inflating portion 28 &the head portion facing portion 28A).

Here, the present embodiment is structured to have the pair of first inflating portions 26, and the second inflating portion 28 that, in the state after inflation, is apart from the floor 18. With this structure, the volume of the inflating portion 24 (the first inflating portions 26 and the second inflating portion 28) can be made to be small as compared with a structure in which a single inflating portion is expanded between the front seats 16F and the rear seats 16R (a structure in which a portion corresponding to the first partitioning all shaped member 30 also is inflated). Due thereto, the inflating portion 24 (the first inflating portions 26 and the second inflating portion 28) can be expanded quickly between the front seats 16F and the rear seats 16R. Further, in this structure, the force by which the inflating portion 24 (the second inflating portion 28) throws the leg portions of the passengers P up can be reduced as compared with a structure in which a single inflating portion is expanded between the front seats 16F and the rear seats 16R (a structure in which a portion corresponding to the first partitioning wall shaped member 30 also is inflated).

Further, in the present embodiment, in the state in which the expansion of the inflating portion 24 (the first inflating portions 26 and the second inflating portion 28) is completed, the lower side of the second inflating portion 28 is partitioned in the longitudinal direction by the first partitioning wall shaped member 30. Due thereto, baggage or the like moving from the side of ones of the vehicle seats 16 toward the side of the other vehicle seats 16 can be suppressed by the first partitioning wall shaped member 30. Further, the first partitioning wall shaped member 30 connects the floor 18 and the second inflating portion 28. Due thereto, at the time when gas is supplied from the first inflating portion 26 at the vehicle transverse direction one side to the second inflating portion 28, the second inflating portion 28 swinging can be suppressed.

### Passenger Protecting Devices relating to Second through Fourth Embodiments

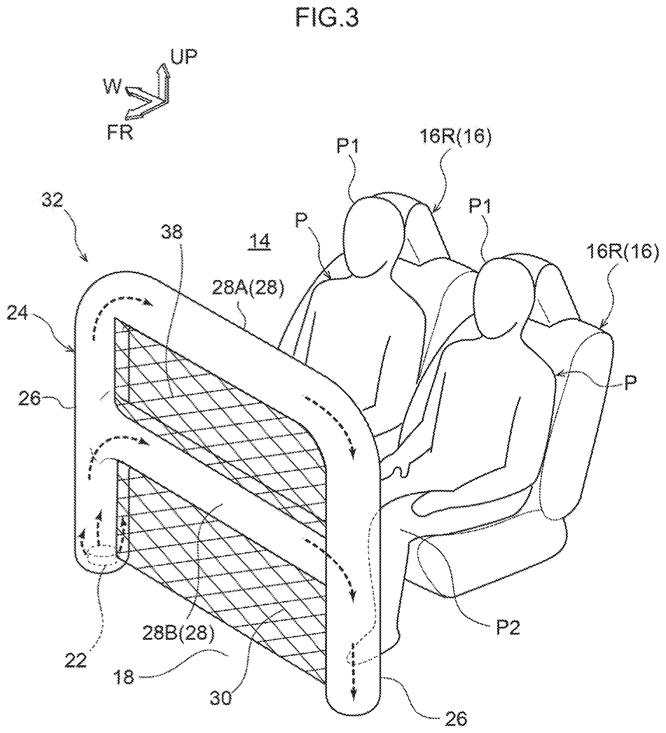

Passenger protecting devices 32, 34, 36 relating to a second embodiment through a fourth embodiment of the present disclosure are described next by using FIG. 3 through FIG. 5. Note that, in the passenger protecting devices 32, 34, 36 relating to the second embodiment through the fourth embodiment, members and portions that correspond to those of the previously-described passenger protecting device(s) are denoted by the same reference numerals as the corresponding members and portions of the previously-described passenger protecting device(s), and there are cases in which description thereof is omitted.

### Passenger Protecting Device 32 of Second Embodiment

As shown in FIG. 3, the passenger protecting device 32 of the second embodiment has the feature of having a pair of the second inflating portions 28 that are disposed with an interval therebetween in the vertical direction in the state in which the expansion of the inflating portion 24 is completed. Among the pair of second inflating portions 28, the second inflating portion 28 that is at the upper side is the head portion facing portion 28A that is positioned so as to face, in the seat longitudinal direction, the head portions P1 of the passengers P who are seated in the front seat 16F and the rear seat 16R. Further, among the pair of second inflating portions 28, the second inflating portion 28 that is at the lower side is a knee facing portion 28B that is disposed so as to face, in the seat longitudinal direction, knees P2 of the passengers P who are seated in the front seats 16F and the rear seats 16R,

Further, the passenger protecting device 32 of the second embodiment is provided with a second partitioning wall shaped member 38 that serves as a partitioning wall shaped member, and that connects the pair of second inflating portions 28 (the bead portion facing portion 28A and the knee facing portion 28B) that are in the state in which expansion of the inflating portion 24 has been completed, and that connects the pair of first inflating portions 26 in the vehicle transverse direction.

In accordance with the above-described passenger protecting device 32 of the second embodiment, the head portions PI of the passengers P can be restrained by one of the second inflating portions 28 (the head portion facing portion 28A), and the knees P2 of the passengers P can be restrained by the other second inflating portion 28 (the knee facing portion 28B).

Further, due to the second partitioning wall shaped member 38 being provided, the vertical interval between the pair of second inflating portions 28 (the head portion facing portion 28A and the knee facing portion 28B) after inflation can be made to be a desired interval.

### Passenger Protecting Device 34 of Third Embodiment and Passenger Protecting Device 36 of Fourth Embodiment

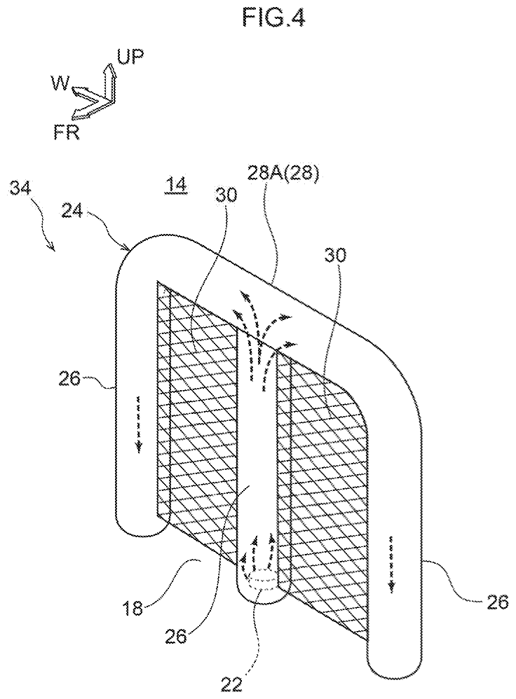

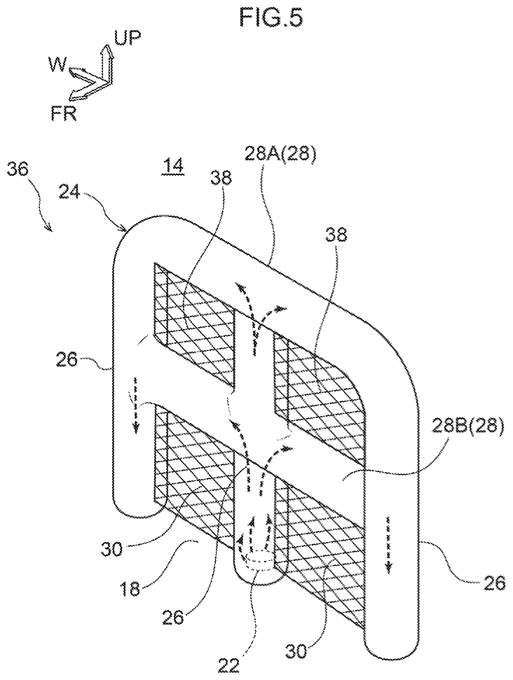

As shown in FIG. 4 and FIG. 5, the passenger protecting device 34 of the third embodiment and the passenger protecting device 36 of the fourth embodiment have the features of having three of the first inflating portions 26 that are disposed at intervals in the vehicle transverse direction. As shown in FIG. 4, in the passenger protecting device 34 of the third embodiment, of the three first inflating portions 26, the first inflating portion 26 that is disposed at the central portion in the vehicle transverse direction is connected to the vehicle transverse direction central portion of the second inflating portion 28 (the head portion facing portion 28A).

Further, as shown in FIG. 5, in the passenger protecting device 36 of the fourth embodiment, of the three first inflating portions 26, the first inflating portion 26 that is disposed at the central portion in the vehicle transverse direction is connected to the vehicle transverse direction central portion of the one second inflating portion 28 (the head portion facing portion 28A) and is connected to the vehicle transverse direction central portion of the another second inflating portion 28 (the knee facing portion 28B).

Further, as shown in FIG. 4 and FIG. 5, in the passenger protecting device 34 of the third embodiment and the passenger protecting device 36 of the fourth embodiment, the inflator 22 is connected to the lower side of the first inflating portion 26 that is disposed at the vehicle transverse direction central portion among the three first inflating portions 26.

In the above-described passenger protecting device 34 of the third embodiment and passenger protecting, device 36 of the fourth embodiment, due to the inflator 22 being connected to the lower side of the first inflating portion 26 which is disposed at the vehicle transverse direction central portion among the three first inflating portions 26, the inflating portion 24 (the first inflating portions 26 and the second inflating portion(s) 28) can be expanded more uniformly in the vehicle transverse direction.

Note that description is given of examples in which there are two or three of the first inflating portions 26 in the above-described passenger protecting devices 10, 32, 34, 36. However, the present disclosure is not limited to this. For example, the number of the first inflating portions 26 may be one or may be four or more. In this way, it suffices to set the number of the first inflating portions 26 appropriately in consideration of the dimension of the cabin 14 in the vehicle transverse direction, the number of the vehicle seats 16, and the like.

Further, description is given of examples in which the above-described passenger protecting devices 10, 32, 34, 36 are provided with the first partitioning wall shaped member 30 and the second partitioning wall shaped member 38, but the present disclosure is not limited to this. Whether or not the first partitioning wall shaped member 30 and the second partitioning wall shaped member 38 are to be provided may be determined appropriately in consideration of structures such as accommodating portions (portions in which baggage or the like is accommodated) that are provided within the cabin 14, or the like. Further, there may be a structure in which the lower end portion of the first partitioning wall shaped member 30 is apart from the floor 18 (the airbag case 21). In this case as well, provided that both side portions of the first partitioning wall shaped member 30 are fixed to the first inflating portions 26 and that the upper end portion of the first partitioning wall shaped member 30 is fixed to the second inflating portion 28, sufficient tension is applied, and the effect of protecting the passengers is obtained.

Note that, although embodiments of the present invention have been described above, the present disclosure is not limited to the above, and, of course, can be implemented by being modified in various ways other than the above within a scope that does not depart from the gist thereof.

An object of the present disclosure is to provide a passenger protecting device that can quickly expand an inflating portion between vehicle seats that are disposed so as to face one another.

A first aspect of the present disclosure is a passenger protecting device that includes: a first inflating portion that is provided between vehicle seats disposed so as to face one another, and that inflates in a vehicle vertical direction with respect to a floor of a vehicle body due to gas being supplied to an interior of the first inflating portion; and a second inflating portion that is connected to the first inflating portion and that inflates due to gas being supplied thereto from the first inflating portion, in a state after inflation, the second inflating portion being disposed so as to face, in a seat longitudinal direction, passengers in a state in which the passengers are seated in the vehicle seats that are disposed so as to face one another, and being apart from the floor of the vehicle body.

In accordance with the passenger protecting device of the first aspect, when gas is supplied to the interior of the first inflating portion, the first inflating portion inflates in the vehicle vertical direction with respect to the floor of the vehicle body. Further, when gas is supplied from the first inflating portion to the second inflating portion, the second inflating portion inflates, and the second inflating portion is disposed so as to face, in the seat longitudinal direction, passengers who are seated in the vehicle seats that are disposed so as to face one another. Due thereto, at the time of a collision of the vehicle for example, the bodies of the passengers who move toward the seat front sides can be restrained by the second inflating portion. Here, the passenger protecting device of the first aspect is structured to have the first inflating portion and the second inflating portion which, in a state after inflation, s apart from the floor of the vehicle body. With this structure, the volume of the inflating portion (the first inflating portion and the second inflating portion) can be made to be small as compared with a structure in which a single inflating portion having a same protecting region for example is expanded between the vehicle seats that are disposed so as to face one another. Due thereto, the inflating portion (the first inflating portion and the second inflating portion) can be expanded quickly between the vehicle seats that are disposed so as to face one another.

A second aspect of the present disclosure is the first aspect of the passenger protecting device, wherein a first partitioning wall-shaped member, which connects the floor of the vehicle body and the second inflating portion and which partitions, in the seat longitudinal direction, a region between the vehicle seats that are disposed so as to face one another, is provided at a lower side of the second inflating portion after inflation.

In accordance with the passenger protecting device of the second aspect, the first partitioning wall shaped member is provided at the lower side of the second inflating portion after inflating. Due thereto, baggage or the like moving from the side of ones of the vehicle seats toward the side of the other vehicle seats can be suppressed by the first partitioning wall shaped member. Further, the first partitioning wall shaped member connects the floor of the vehicle body and the second inflating portion. Due thereto, at the time when gas is supplied from the first inflating portion to the second inflating portion, the second inflating portion shaking can be suppressed (the movement of the second inflating portion can be stabilized).

A third aspect of the present disclosure is the first or the second aspect of the passenger protecting device, wherein the second inflating portion includes a head portion-facing portion that, after inflating, is disposed so as to face, in the seat longitudinal direction, head portions of the passengers in the state in which the passengers are seated in the vehicle seats that are disposed so as to face one another.

In accordance with the passenger protecting device of the third aspect, when the head portion facing portion of the second inflating portion inflates, the head portion facing Portion is disposed so as to face, in the seat longitudinal direction, the head portions of the passengers who are seated in the vehicle seats that are disposed so as to face one another. Due thereto, at the time of a collision of the vehicle, the head portions of the passengers that have moved toward the seat front sides can be restrained by the head portion facing portion of the second inflating portion.

A fourth aspect of the present disclosure is the first or the second aspect of the passenger protecting device, wherein the second inflating portion includes a knee-facing portion that, after inflating, is disposed so as to face, in the seat longitudinal direction, knees of the passengers in the state in which the passengers are seated in the vehicle seats that are disposed so as to face one another.

In accordance with the passenger protecting device of the fourth aspect, when the knee facing portion of the second inflating portion inflates, the knee facing portion is disposed so as to face, in the seat longitudinal direction, the knees of the passengers who are seated in the vehicle seats that are disposed so as to face one another. Due thereto, at the time of a collision of the vehicle, the knees of the passengers that have moved toward the seat front sides can be restrained by the knee facing portion of the second inflating portion.

A fifth aspect of the present disclosure is the fourth aspect of the passenger protecting device according to the third aspect of the passenger protecting device, wherein a second partitioning wall-shaped member, which connects the head portion-facing portion and the knee-facing portion and partitions, in the seat longitudinal direction, a region between the vehicle seats that are disposed so as to face one another, is provided between the head portion-facing portion after inflating and the knee-facing portion after inflating.

In accordance with the passenger protecting device of the fifth aspect, the second partitioning wall shaped member, which connects the head portion facing portion after inflation and the knee facing portion after inflation, is provided between the both after they have inflated. Due thereto, the interval between the head portion facing portion after inflation, and the knee facing portion after inflation can be made to be a desired interval by the second partitioning wall shaped member.

A sixth aspect of the present disclosure is any one of the first to the fifth aspect of the passenger protecting device, that includes a plurality of first inflating portions that are disposed with intervals therebetween in a seat transverse direction, wherein: the plurality of first inflating portions are connected in the seat transverse direction via the second inflating portion, and gas from an inflator is supplied to a first inflating portion that is disposed at a seat transverse direction one side among the plurality of first inflating portions.

In accordance with the passenger protecting device of the sixth aspect, the plural first inflating portions, which are disposed with intervals therebetween in the seat transverse direction, are provided. The plural first inflating portions are connected in the seat transverse direction via the second inflating portion. In this structure, the volume of the inflating portion (the first inflating portions and the second inflating portion) can be made to be small as compared with a structure in which a single inflating portion having a same protecting region for example is expanded between the vehicle seats that are disposed so as to face one another. Due thereto, the inflating portion (the first inflating portions and the second inflating portion) can be expanded quickly, even in the case of a structure in which gas from an inflator s supplied to the first inflating portion that is disposed at a seat transverse direction one side among the plural first inflating portions.

A seventh aspect of the present disclosure is any one of the first to the sixth aspect of the passenger protecting device, that includes a plurality of first inflating portions that are disposed with intervals therebetween in a seat transverse direction, wherein: the plurality of first inflating portions are connected in the seat transverse direction via the second inflating portion, and gas from an inflator is supplied to a first inflating portion drat is disposed at a seat transverse direction central portion among the plurality of first inflating portions.

In accordance with the passenger protecting device of the seventh aspect, the plural first inflating portions, which are disposed with intervals therebetween in the seat transverse direction, are provided. The plural first inflating portions are connected in the seat transverse direction via the second inflating portion. In this structure, the volume of the inflating portion (the first inflating portions and the second inflating portion) can be made to be small as compared with a structure in which a single inflating portion having a same protecting region for example is expanded between the vehicle seats that are disposed so as to face one another. Due thereto, the inflating portion (the first inflating portions and the second inflating portion) can be expanded quickly, even in the case of a structure in which gas from an inflator is supplied to the first inflating portion that is disposed at the seat transverse direction central portion among the plural first inflating portions.

The passenger protecting device relating to the present disclosure can quickly expand an inflating portion between vehicle seats that are disposed so as to face one another.

1. A passenger protecting device comprising:
a first inflating portion that is provided between vehicle seats disposed so as to face one another, and that inflates in a vehicle vertical direction with respect to a floor of a vehicle body due to gas being supplied to an interior of the first inflating portion; and
a second inflating portion that is connected to the first inflating portion and that inflates due to gas being supplied thereto from the first inflating portion, in a state. after inflation the second inflating portion being disposed so as to face, in a seat longitudinal direction, passengers in a state in which the passengers are seated in the vehicle seats that are disposed so as to face one another, and being apart from the floor of the vehicle body.

2. The passenger protecting device of claim 1, wherein a first partitioning wall-shaped member, which connects the floor of the vehicle body and the second inflating portion and which partitions, in the seat. longitudinal direction, a region between the vehicle seats that are disposed so as to face one another, is provided at a lower side of the second inflating portion after inflation.

3. The passenger protecting device of claim 1, wherein the second inflating portion includes a head portion-facing portion that, after inflating, is disposed so as to face, in the seat longitudinal direction, head portions of the passengers in the state in which the passengers are seated in the vehicle seats that are disposed so as to face one another.

4. The passenger protecting device of claim 1, wherein the second inflating portion includes a knee-facing portion that, after inflating, is disposed so as to face, in the seat longitudinal direction, knees of the passengers in the state in which the passengers are seated in the vehicle seats that are disposed so as to face one another.

5. The passenger protecting device of claim 3, wherein the second inflating portion includes a knee-facing portion that, after inflating, is disposed so as to face, in the seat longitudinal direction, knees of the passengers in the state in which the passengers are seated in the vehicle seats that are disposed so as to face one another.

6. The passenger protecting device of claim 5, wherein a second partitioning wall-shaped member, which connects the head portion-facing portion and the knee-facing portion and partitions, in the seat longitudinal direction, a region between the vehicle seats that are disposed so as to face one another, is provided between the head portion-facing portion after inflating and the knee-facing portion after inflating.

7. The passenger protecting device of claim 1, comprising a plurality of first inflating portions that are disposed with intervals therebetween in a seat transverse direction, wherein:
the plurality of first inflating portions are connected in the seat transverse direction via the second inflating portion, and
gas from an inflator is supplied to a first inflating portion that is disposed at a seat transverse direction one side am the plurality of first inflating portions.

8. The passenger protecting device of claim 1, comprising a plurality of first inflating portions that are disposed with intervals therebetween in a seat transverse direction, wherein:
the plurality of first inflating portions are connected in the seat transverse direction via the second inflating portion, and
gas from an inflator is supplied to a first inflating portion that is disposed at a seat transverse direction central portion among the plurality of first inflating portions.

9. The passenger protecting device of claim 1, comprising a plurality of second inflating portions,
wherein the second inflating portions are connected in the vehicle vertical direction via the first inflating portion.
